(19) United States
(12) Patent Application Publication
(10) Pub. No.: US 2006/0147768 A1
(43) Pub. Date: Jul. 6, 2006

(54) System for reformation of fuel for supply to a fuel cell on a motor vehicle and method for operation thereof

(76) Inventors: Fabien Boudjemaa, Puteaux (FR); Gilles Dewaele, Rueil Malmaison (FR); Fahri Keretli, Le Mesnil St-Denis (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/540,126

(22) PCT Filed: Dec. 19, 2003
(86) PCT No.: PCT/FR03/03848

§ 371 Date: Nov. 14, 2005

(30) Foreign Application Priority Data
Dec. 24, 2002 (FR) 02/16600

(51) Int. Cl. H01M 8/04; H01M 8/06; B01J 8/04

(52) U.S. Cl. 429/23; 429/17; 422/189

(57) ABSTRACT

The invention relates to a system (1) for the reformation of fuel for the supply of hydrogen to a fuel cell (2), in particular for a motor vehicle of the type comprising a reformer device (29), a hydrogen enrichment device (33, 34) for the reformate produced by the reformer and a purification device (32) for the reformate by means of reaction with carbon monoxide. The above is characterized in comprising at least two separate paths (a, b) each comprising at least one of the above devices and a control means (39) for the selection of one path or all the paths at the same time.

The present invention relates to supplying hydrogen to a fuel-cell stack, especially one designed for a motor vehicle equipped with an electrical propulsion motor, the fuel-cell stack being supplied with hydrogen obtained by reforming a hydrocarbon fuel.

The fuel-cell stack is composed of an electrochemical generator supplied both with hydrogen and with oxygen contained in the air. Such a fuel-cell stack can be used to supply an electrical propulsion train in a motor vehicle. In this way it is possible to achieve functioning comparable to that of a conventional vehicle equipped with an internal combustion engine supplied with fuel, while considerably reducing the emissions of carbon dioxide and polluting gases.

The use of a hydrocarbon fuel for production of the hydrogen necessary for supplying the fuel-cell stack requires the installation in the vehicle of a reforming system capable of extracting the hydrogen from the fuel, which can be gasoline, methanol or any other hydrocarbon fuel.

In general, a reforming system contains substantially three main components.

The reforming system firstly contains a reforming device or actual reformer that produces a hydrogen-rich gaseous mixture from the primary fuel by a catalytic reforming process. Different types of reformers are known. The present description will address mainly reformers that are thermally self-sufficient during continuous operation, generally called ATR (Auto Thermal Reformer). It will be understood, of course, that the invention could be applicable under the same conditions to reformers based on a different technology.

The reforming system additionally contains a device for hydrogen enrichment of the reformate obtained from the reformer device, by a reaction involving water vapor at elevated temperature. In practice, this enrichment device is often composed of two parts, one at high temperature (HTS), the other at lower temperature (LTS).

Finally, the reformer system also contains a device for purifying the reformate by reacting the carbon monoxide in such a way as to eliminate this gas from the hydrogen-rich gaseous mixture obtained from the reformer device before it is supplied to the fuel-cell stack.

These three devices must be brought to their optimal operating temperature to be fully functional. For example, in the case of gasoline reforming, the optimal temperatures are on the order of 800° C. for the reformer of ATR type, 400° C. for the hydrogen-enrichment device and 150° C. for the carbon monoxide purification device.

These temperatures are generally achieved by using a burner integrated in the reforming system and supplied with fuel. The relatively high thermal inertia of the components of the reforming system necessitates the combustion of a certain quantity of fuel, thus leading to an increase of consumption. Although this increase of consumption may be considered slight in the case of long vehicle journeys at high speed, the situation is different for short trips at low speed, involving several cold starts within a limited time period. This is the case in particular during urban use of a vehicle equipped with a fuel-cell stack.

International Patent Application WO 0031816 describes a miniaturized reformer for a motor vehicle combining the reforming and purification steps in a single reactor. The possibility of providing a plurality of modules connected in series or in parallel is raised in that document, albeit without mentioning an advantage in terms of consumption and of driving the vehicle.

The object of the present invention is therefore a system for supplying a fuel-cell stack of a motor vehicle with hydrogen by reforming fuel, thus permitting savings in fuel consumption, especially in the case of urban trips at low speed.

Another object of the invention is such a system capable of offering the driver, in simple manner, a possibility of varying the available power.

The fuel-reforming system according to the invention, for supplying hydrogen to a fuel-cell stack, especially one intended for a motor vehicle, comprises a reformer device, a device for hydrogen enrichment of the reformate obtained from the reformer, and a device for purifying the reformate by reacting the carbon monoxide. At least two separate channels are provided, each containing at least one of the aforesaid devices and a control means for choosing one of the channels or all of the channels simultaneously.

In this way, the vehicle driver can easily choose the power suited to each driving situation.

In one embodiment, each of the separate channels is provided with a reformer device, a device for hydrogen enrichment of the reformate obtained from the reformer, and a device for purifying the reformate by reacting the carbon monoxide. The two channels installed in parallel therefore duplicate each device.

In another embodiment, each of the separate channels is provided with a reformer device, the separate channels being merged as a single channel provided with a common device for hydrogen enrichment of the reformate obtained from the reformers of the different channels, and a common device for purifying the reformate by reacting the carbon monoxide.

In another embodiment, each of the separate channels is provided with a reformer device and a device for hydrogen enrichment of the reformate obtained from the reformer, the separate channels being merged as a single channel provided with a common device for purifying the reformate by reacting the carbon monoxide.

In an alternative version, each of the separate channels can be provided with a reformer device and a high-temperature part of a device for hydrogen enrichment of the reformate obtained from the reformer, the separate channels being merged as a single channel provided with a common lower-temperature part of the device for hydrogen enrichment of the reformate obtained from the reformer and a common device for purifying the reformate by reacting the carbon monoxide.

Preferably, each of the separate devices is suitable for delivering a different hydrogen flow corresponding to a different power of the fuel-cell stack. The driver can then easily choose the channel that corresponds to the desired power.

Advantageously, the control means is also suitable for controlling the flow of fuel supplying the system, as a function of the channel or channels chosen.

The method according to the invention of supplying a fuel-cell stack of a motor vehicle with hydrogen uses a fuel-reforming process with hydrogen enrichment of the reformate and purification of the reformate by reacting the carbon monoxide. In addition, the flow of hydrogen supplying the fuel-cell stack is controlled as a function of the desired power, by using one or more individual reforming channels.

The invention will be better understood by studying several embodiments presented as examples in no way limitative, and illustrated by the attached drawings, wherein:

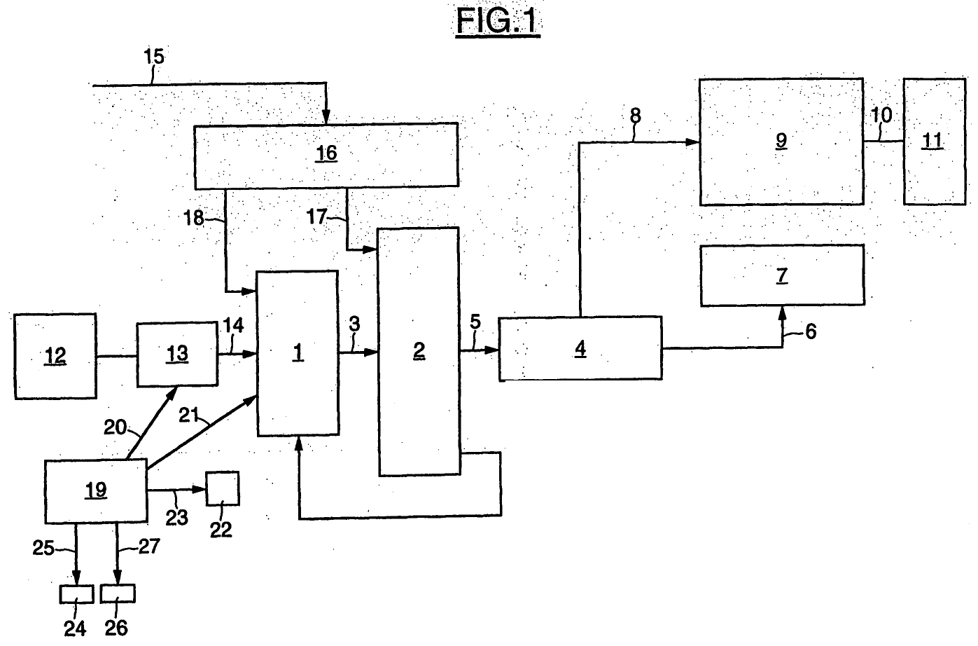

FIG. 1 shows the main elements of a propulsion train of a motor vehicle provided with a fuel-reforming system and a fuel-cell stack;

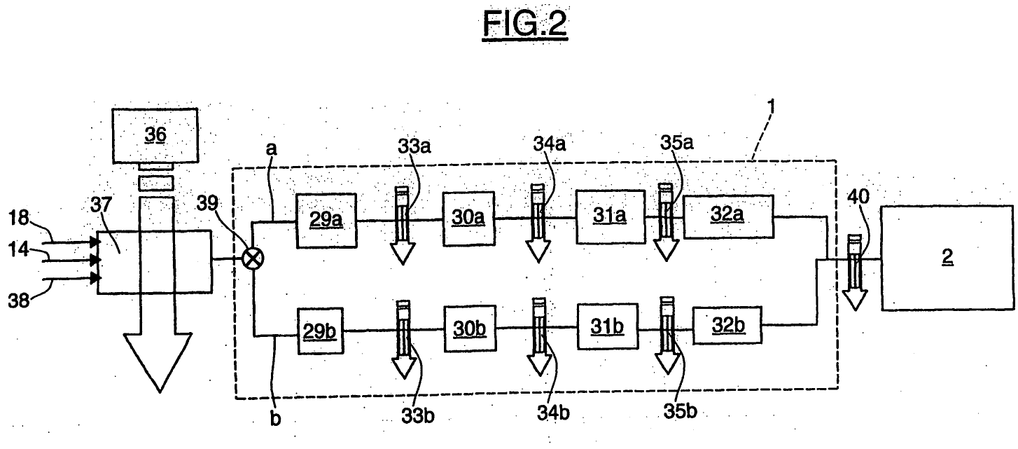

FIG. 2 shows a first embodiment of a reforming system according to the invention, with two distinct complete channels;

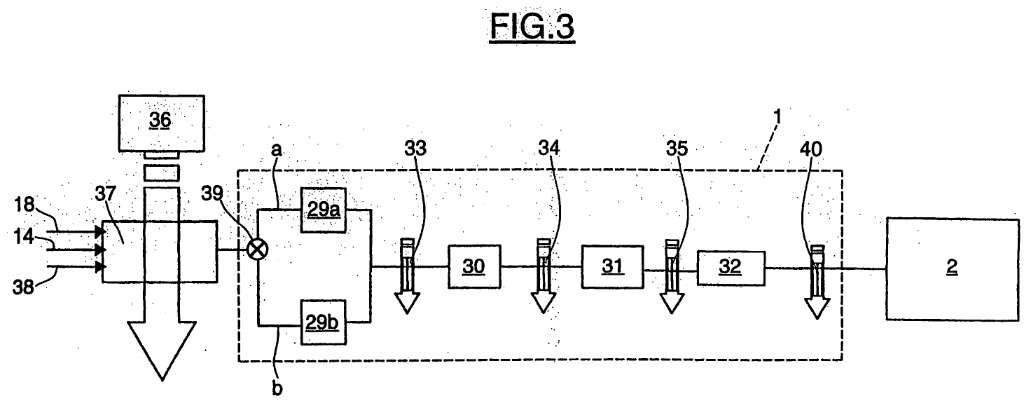

FIG. 3 illustrates a second embodiment of a reforming system according to the invention, with two partial channels merging into a single channel;

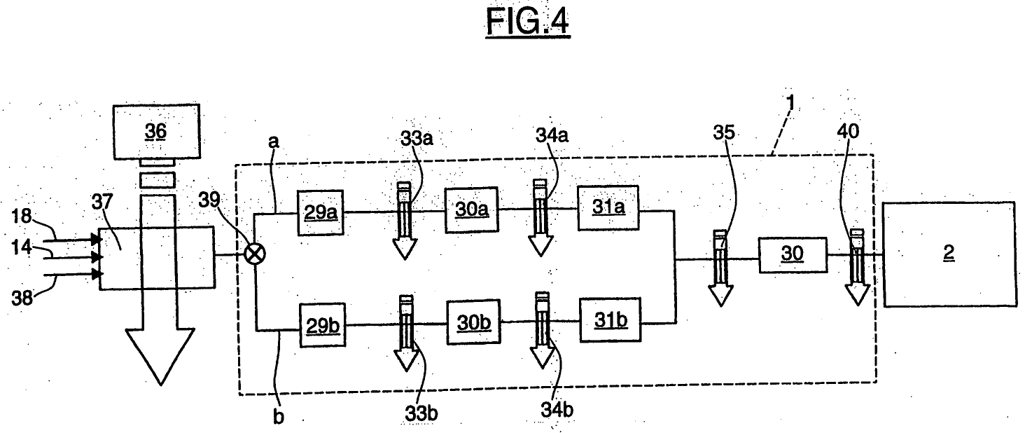

FIG. 4 illustrates a third embodiment of a reforming system according to the invention, with two partial channels merging into a single channel; and

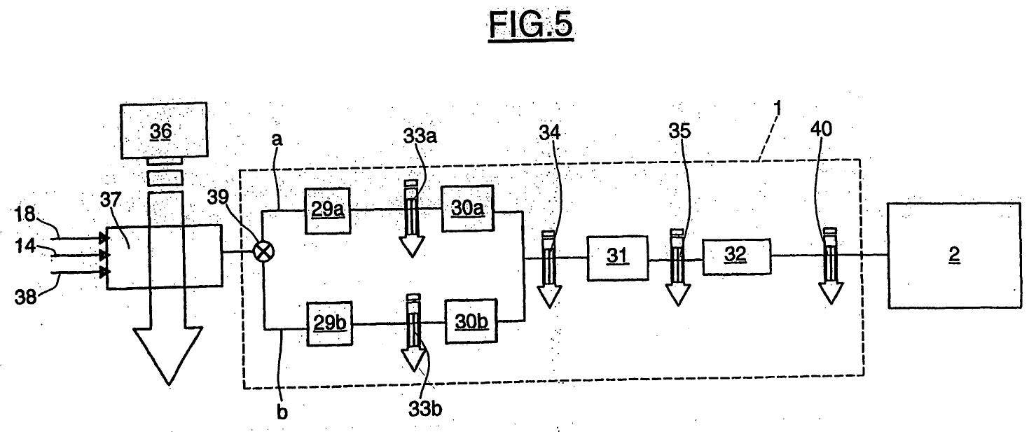

FIG. 5 illustrates an alternative version of the embodiment of FIG. 4.

As illustrated in FIG. 1, a reforming system 1 supplies a fuel-cell stack 2 with hydrogen via line 3. The electric current generated by fuel-cell stack 2 is delivered to a converter 4 connected to fuel-cell stack 2 by electrical connection 5. An electrical connection 6 connects converter 4 to power battery 7 with which the vehicle is equipped. The electrical current output by converter 4 is delivered via electrical connection 8 to electric motor 9 of the vehicle, which motor is connected by shaft 10 to the transmission and to the vehicle wheels indicated schematically by block 11.

A fuel tank 12 is equipped with a pump 13 capable of delivering the fuel via line 14 to reforming system 1.

The air is delivered via line 15 to a compressor 16 before being guided via lines 17 and 18 respectively into fuel-cell stack 2 and into reforming system 1.

An electronic control unit 19 is capable of sending control signals to fuel pump 13 via connection 20 and to reforming system 1 via connection 21, in such a way as to control it, as will be seen hereinafter.

Via connection 23, a power-indicator device 22 receives a signal from electronic control unit 19, in order to inform the driver of the power available for the propulsion motor.

Also shown in FIG. 1 is a mode-selector button 24 connected via connection 25 to electronic control unit 19, as well as an anti-theft contactor device 26, also connected via connection 27 to the electronic control unit. It will be understood, of course, that other means could be provided, the means described merely being so by way of example.

During operation, when the electronic control unit has received a signal from anti-theft contactor 26 and from mode-selector button 24, the control unit is enabled to instruct pump 13 to supply reforming system 1. This system, appropriately heated by means that are not illustrated in FIG. 1, and supplied with compressed air by compressor 16, produces a hydrogen-rich reformate, which is appropriately purified, as will be seen hereinafter, in order to supply fuel-cell stack 2. An excess part of the hydrogen is returned to reforming system 1 via conduit 28.

Just as is the case for a vehicle equipped with an internal combustion engine, the vehicle equipped with these different means must be capable of adapting as readily to urban use, where the mean power consumed by the propulsion train is low, as it does to open-road or highway use, where the mean power consumed is, on the contrary, higher.

An object of the present invention is to permit these two types of uses while reducing the consumption, in such a way as to assure operation comparable to that of a conventional vehicle but with the advantages associated with electrical propulsion.

The solution proposed according to the present invention is to install in the reforming system at least two separate channels, which can be chosen individually or together by the driver depending on the desired power.

FIG. 2 illustrates a first embodiment of the invention, in which reforming system 1 contains two channels, each provided with the same components. The two channels, a and b, are disposed in parallel. They are each provided with a reformer device 29a, 29b, a device 30a, 30b for hydrogen enrichment at high temperature, a second device 31a, 31b for hydrogen enrichment at lower temperature, and a device 32a, 32b for purification by reacting the carbon monoxide in the produced reformate. The optimal operating temperature of each of these devices is assured by heat exchangers denoted by 33a, 33b, 34a, 34b, 35a, 35b.

A burner 36 produces heat energy that is delivered to a heat exchanger 37 that receives air from line 18. The hot air exiting exchanger 37 passes through reactors 29, 30, 31 and 32, thus making it possible to heat them. The combustion gases exiting burner 36 also pass through the different heat exchangers 33, 34 and 35, after having passed through heat exchanger 37. The double input of heat shortens the heatup time of the installation. In a second stage, exchanger 37 is used to vaporize the fuel delivered via line 14 and the water delivered via line 38. The fuel and the water vaporized in heat exchanger 37 can be delivered into one or the other of channels a, b or into both channels simultaneously, depending on the position of a valve 39 pilot-controlled by a signal originating from electronic control unit 19, visible in FIG. 1.

The two channels a and b merge at the inlet to fuel-cell stack 2, the hydrogen-rich gaseous mixture being brought to the appropriate temperature by passage into a heat exchanger 40.

In such an embodiment using two duplicate channels, the different components of the devices of one of the channels, for example channel a, will be chosen in such a way as to deliver a power, for example on the order of 60 kW, while the components of the devices of channel b will be chosen in such a way as to deliver a lower power, for example on the order of 20 kW.

During starting of the vehicle, the driver then has the ability to choose between two modes of operation:

According to a first mode of operation, the driver can favor consumption, by then activating only lower-power channel b, on the order of 20 kW, during starting. The quantity of fuel consumed to bring the reforming system to temperature is then reduced.

According to a second mode of operation, the driver can favor vehicle performance, by then activating both channels a and b simultaneously during starting of the vehicle. However, that requires that all devices of the two channels a and b be heated simultaneously, which entails a notable increase of the consumption of the vehicle. Nevertheless, once heating has been completed, the entire power installed in the vehicle is then at the driver's disposal.

It is also possible for the driver to select a particular mode of operation while the vehicle is rolling.

As in the illustrated example, the interface that permits the driver to choose modes of operation can be a simple mode-selector button, denoted by 24 in FIG. 1.

It will be noted that power indicator 22, pilot-controlled by electronic control unit 19, signals to the driver the channels that are operational, in order that the driver can adapt his driving to the available power.

The operational logic of this embodiment is as follows:

The electronic control unit continuously scans the position of anti-theft contactor 26 or of the starter button of the motive power group. As soon as anti-theft contactor 26 or the starter button occupies the “start” position, the electronic control unit tests the position of mode-selector button 24.

If the “low consumption” mode is selected, the electronic control unit activates burner 36 and adapts the fuel flow by instructing pump 13 to supply burner 36 in order to heat channel b of the reforming system, or in other words the lower-power channel.

If, on the other hand, the “performance” mode is selected by the driver, the electronic control unit activates the burner and adapts the fuel flow supplying burner 36 in such a way as to permit heating of both channels a and b.

In both cases, the fuel-cell stack can be supplied as soon as the operating temperature of the reactors is reached. From that moment on, the electronic control unit assures the generation of electrical power by the fuel-cell stack as a function of the driver's demand, for example according to the accelerator position. The total available electrical power depends not only on the mode selected by the driver but also on the energy management adopted for the vehicle, which can be programmed into the electronic control unit.

In the low-consumption mode of operation, only channel b of the reforming system produces hydrogen for supplying fuel-cell stack 2. The power delivered by the battery is added to the power generated by fuel-cell stack 2, provided the vehicle speed does not exceed the speed that can be achieved with the power delivered solely by stack 2 supplied with hydrogen via channel b, this speed being lower than the maximum vehicle speed that can be achieved when the stack is being supplied with H₂ by both channels a and b. Such energy management makes it possible to provide, for accelerations, the power from the battery in addition to the power from the stack supplied with hydrogen by only one of the channels. The power available from the battery is not used continuously, given that the vehicle speed is limited to that which can be achieved with production of H₂ from channel b alone. This avoids discharging the battery by a continuous power demand. By virtue of the battery, the vehicle accelerations are not affected by the fact that only channel b of the reformer is in operation.

In the mode of operation that favors performance, both channels of the reforming system produce hydrogen that supplies fuel-cell stack 2. The power delivered by battery 7 is also added to the power generated by fuel-cell stack 2, provided the total power obtained in this way does not exceed the maximum power of fuel-cell stack system 2. Such energy management makes it possible to utilize the battery power to compensate for the response time of the fuel-cell stack system during an increase of the power demanded by the propulsion train. This makes it possible to achieve excellent accelerations without running the risk of degrading the vehicle performances by discharging the battery, since the maximum power delivered to the electric motor does not exceed the maximum power of the fuel-cell stack system.

If the driver switches from the low-consumption mode to the mode favoring performance while the vehicle is rolling, the electronic control unit is then capable of activating burner 36 and of adapting the fuel flow by instructing pump 13 to supply the burner in order to heat second channel a of the reforming system, while first channel b is already at optimal operating temperature.

Power indicator 22 informs the driver of the available power. At startup of the vehicle, power indicator 22 informs the driver that only the battery is capable of delivering the power. If the mode favoring low consumption is chosen, the indicator informs the driver, as soon as channel b is hot, that only the battery and one of the reformer channels are available. If the mode favoring performance is chosen, the indicator informs the driver, as soon as both channels are at operating temperature, that the full power of the vehicle is available.

FIG. 3 illustrates another embodiment, in which like elements are denoted by like references and/or only the reformer device is duplicated. Once again, therefore, the two channels a and b are present, each provided with a reformer device 29a and 29b. However, the two channels a and b merge into a single channel at the outlet of reformer devices 29a and 29b. The single channel then contains a single device denoted by 30 for hydrogen enrichment at high temperature, a single device denoted by 31 for hydrogen enrichment at low temperature, and a single purification device 32. The same exchangers 33, 34, 35 and 40 are present as in the embodiment illustrated in FIG. 2.

In the embodiment illustrated in FIG. 4, channels a and b each contain a reformer 29a, 29b, a device 30a, 30b for enrichment at high temperature and a device 31a, 31b for enrichment at low temperature, heat exchangers 33a, 33b, 34a, 34b permitting the different components to be brought to the optimal temperature. The two channels a and b merge into a single channel at the outlet of enrichment device 31a, 31b. Purification device 32 is therefore common to both channels a and b.

In the alternative version illustrated in FIG. 5, the device 31 for enrichment at low temperature is also common to both channels a and b, each of which is provided with a reformer device 29a, 29b, and a device 30, 30b for enrichment at high temperature.

It will be understood, of course, that other architectures could be imagined. In particular, it would be possible to use a larger number of channels than the two channels illustrated by way of examples in the present description, in order to permit the range of choices of the driver to be increased.

The present invention permits the driver to choose, for driving in the city, an operation of the vehicle with reduced consumption in exchange for a temporary reduction of the vehicle performances. The choice of mode of operation of the vehicle remains under the control of the driver, who is able at any time to switch from an economical mode of low consumption to a mode favoring performance and corresponding to the full power installed on board the vehicle.

1. A fuel-reforming system for supplying hydrogen to a fuel-cell stack comprising a reformer device, a device for hydrogen enrichment of the reformate obtained from the reformer, and a device for purifying the reformate by reacting the carbon monoxide, wherein the fuel-reforming system comprises at least two separate channels, each provided with at least one of the aforesaid devices and a control means for choosing one of the channels or all of the channels simultaneously.

2. The fuel-reforming system according to claim 1, wherein each of the separate channels is provided with a reformer device, a device for hydrogen enrichment of the reformate obtained from the reformer, and a device for purifying the reformate by reacting the carbon monoxide.

3. The fuel-reforming system according to claim 1, wherein each of the separate channels is provided with a reformer device, the separate channels being merged as a single channel provided with a common device for hydrogen enrichment of the reformate obtained from the reformers of the different channels, and a common device for purifying the reformate by reacting the carbon monoxide.

4. The fuel-reforming system according to claim 1, wherein each of the separate channels is provided with a reformer device and a device for hydrogen enrichment of the reformate obtained from the reformer, the separate channels being merged as a single channel provided with a common device for purifying the reformate by reacting the carbon monoxide.

5. The fuel-reforming system according to claim 1, wherein each of the separate channels is provided with a reformer device and a high-temperature part of a device for hydrogen enrichment of the reformate obtained from the reformer, the separate channels being merged as a single channel provided with a common lower-temperature part of the device for hydrogen enrichment of the reformate obtained from the reformer and a common device for purifying the reformate by reacting the carbon monoxide.

6. The fuel-reforming system according to claim 1, wherein each of the separate channels is adapted to deliver a different hydrogen flow corresponding to a different power of the fuel-cell stack.

7. The fuel-reforming system according to claim 1, wherein the control means is also adapted to control the flow of fuel supplying the system, as a function of the channel or channels chosen.

8. A method for control of the electrical power supplying an electrical propulsion unit of a motor vehicle equipped with a battery and a fuel-cell stack supplied with hydrogen produced by means of fuel reforming, wherein the flow of hydrogen supplying the fuel-cell stack is controlled as a function of the desired power, with one or more individual reforming channels.

9. The method according to claim 8, wherein a single reforming channel is used and in that the power delivered by the battery is added to the power delivered by the fuel-cell stack as long as the vehicle speed is below the speed that could be achieved without the battery.

10. A method according to claim 8, wherein all reforming channels are used simultaneously and in that the power delivered by the battery is added to the power delivered by the fuel-cell stack as long as the total power is below the maximum power delivered by the fuel-cell stack.

11. A motor vehicle comprising the fuel-reforming system as claimed in claim 1.
